(19) United States
(12) Patent Application Publication
(10) Pub. No.: US 2010/0090149 A1
(43) Pub. Date: Apr. 15, 2010

(54) POPPET VALVE ASSEMBLY, SYSTEM, AND APPARATUS FOR USE IN HIGH SPEED COMPRESSOR APPLICATIONS

(75) Inventors: Gene M. Thompson, Cypress, TX (US); Catherine Jones, Missouri City, TX (US)

Correspondence Address: HAYNES AND BOONE, LLP;IP Section, 2323 Victory Avenue, Suite 700, Dallas, TX, 75219, US

(73) Assignee: COMPRESSOR ENGINEERING CORP., Houston, TX (US)

(21) Appl. No.: 12/572,071

(22) Filed: Oct. 1, 2009

Related U.S. Application Data
(60) Provisional application No. 61/194,882, filed on Oct. 1, 2008.

(51) Int. Cl. F16K 1/00

(52) U.S. Cl. 251/321; 251/359

(57) ABSTRACT

A poppet valve assembly for a high-speed compressor, the poppet valve assembly including a cage that includes a plurality of counter bores disposed therein. The poppet valve assembly further includes a plurality of poppets, each poppet having a stem and a head. The head of each poppet has a maximum diameter that is less than approximately 0.75 inches. The stem of the poppet is disposed in each of said counter bores. The poppet valve assembly also includes a seat plate overlying said cage, said seat plate including a plurality of through bores axially aligned with the counter bores of the cage. Each through bore is sized to have a smaller diameter than the maximum diameter of the head. A lift spacer is disposed in each of the counter bores.

### CROSS-REFERENCE TO RELATED APPLICATIONS

This application claims priority from U.S. provisional patent application No. 61/194,882, filed on Oct. 1, 2008 in the U.S. Intellectual Property Office, the disclosure of which is incorporated herein by reference in its entirety.

### BACKGROUND OF THE INVENTION

1. Field of the Invention

The present invention relates to high-speed compressors, and more particularly, to control of gas flow in high-speed compressors utilizing a poppet valve assembly.

2. Description of the Prior Art

Gas valve assemblies for conventional compressors, namely those operating at between approximately 200 rpm and approximately 600 rpm, often include poppets that have a head diameter ranging from approximately 1 inch to approximately 1 and ⅛ inches. Typically, such systems utilize approximately two to four poppets with heads in this size range to control fluid flow within these compressors. The size of such conventional poppets in the valve assemblies of these conventional compressors does not allow for precise control of fluid flow, because a limited number of such conventional poppets may be included within the conventional valve assembly. However, for such conventional operating speeds, these conventional flow control systems have been adequate. There is a need, however, for more precise gas control in certain high-speed compressor applications, particularly those operating in the 600-1500 range or higher.

### SUMMARY

The present disclosure relates generally to a valve assembly that includes miniature poppets which may be utilized with high-speed compressor applications. One of the broader forms of invention may provide a poppet valve assembly, the poppet valve assembly including a cage that includes a plurality of counter bores disposed therein. The poppet valve assembly further includes a plurality of poppets, each poppet having a stem and a head. The head of each poppet has a maximum diameter that is less than approximately one inch. The stem of the poppet is disposed in a corresponding one of the said plurality of counter bores. The poppet valve assembly also includes a seat plate overlying said cage, said seat plate including a plurality of through bores axially aligned with the plurality of counter bores of the cage, wherein each of the plurality of through bores is sized to have a smaller diameter than the maximum diameter of the head. A lift spacer is disposed in each of the counter bores.

According to another of the broader forms of the invention may provide an apparatus that includes a poppet valve assembly, the poppet valve assembly including a cage that includes a plurality of counter bores disposed therein. The poppet valve assembly further includes a plurality of poppets, each poppet having a stem and a head. The head of each poppet has a maximum diameter that is less than approximately one inch. The stem of the poppet is disposed in a corresponding one of the said plurality of counter bores. The poppet valve assembly also includes a seat plate overlying said cage, said seat plate including a plurality of through bores axially aligned with the plurality of counter bores of the cage. Each of the plurality of through bores is sized to have a smaller diameter than the maximum diameter of the head. A lift spacer is disposed in each of the counter bores.

According to another of the broader forms of the invention may provide a system that includes a compressor that includes a poppet valve assembly, the poppet valve assembly including a cage that includes a plurality of counter bores disposed therein. The poppet valve assembly further includes a plurality of poppets, each poppet having a stem and a head. The head of each poppet has a maximum diameter that is less than approximately one inch. The stem of the poppet is disposed in a corresponding one of the said plurality of counter bores. The poppet valve assembly also includes a seat plate overlying said cage, said seat plate including a plurality of through bores axially aligned with the plurality of counter bores of the cage. Each of the plurality of through bores is sized to have a smaller diameter than the maximum diameter of the head. A lift spacer is disposed in each of the counter bores.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a top view of an exemplary poppet valve according to one or more aspects of the present disclosure.

FIG. 2 illustrates a partial cross-sectional view of an exemplary poppet valve according to one or more aspects of the present disclosure.

### DETAILED DESCRIPTION

The present disclosure relates generally to a valve assembly that includes miniature poppets which may be utilized with high-speed compressor applications. It is understood, however, that specific embodiments are provided as examples to teach the broader inventive concept, and one of ordinary skill in the art can easily apply the teaching of the present disclosure to other methods or apparatus. Also, it is understood that the apparatus discussed in the present disclosure includes some conventional structures. Since these structures are well known in the art, they will only be discussed in a general level of detail. Furthermore, reference numbers are repeated throughout the drawings for sake of convenience and example, and such repetition does not indicate any required combination of features or steps throughout the drawings.

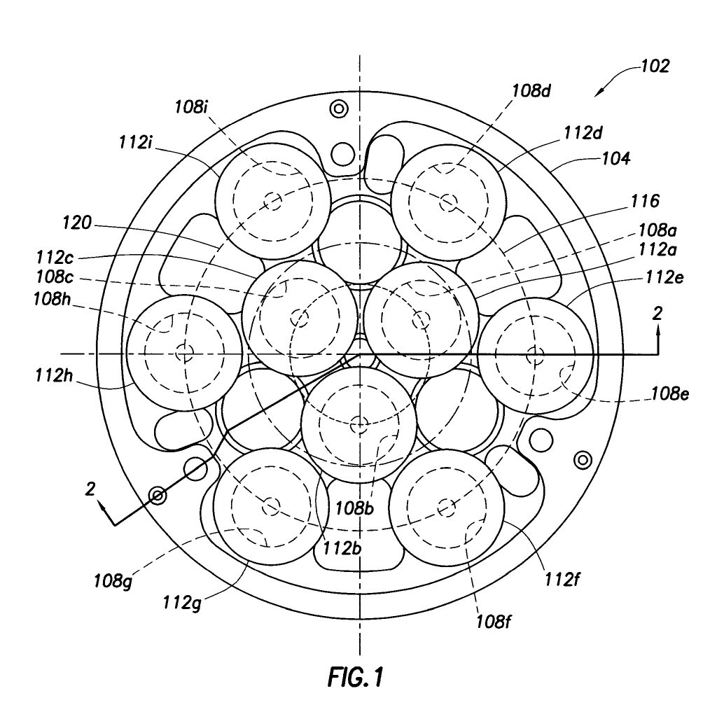

Referring to FIG. 1, a top view of a poppet valve assembly 102 in accordance with an embodiment of the present disclosure is shown. The poppet valve assembly 102 includes a cage, stop plate or guard 104 in which a plurality of counter bores 108 (shown as 108a-i in FIG. 1) are disposed In one preferred embodiment, cage 104 may be substantially circular in shape although the shape of cage 104 is not a limitation of the invention and those skilled in the art will understand that cage 104 can be of any desirable shape.

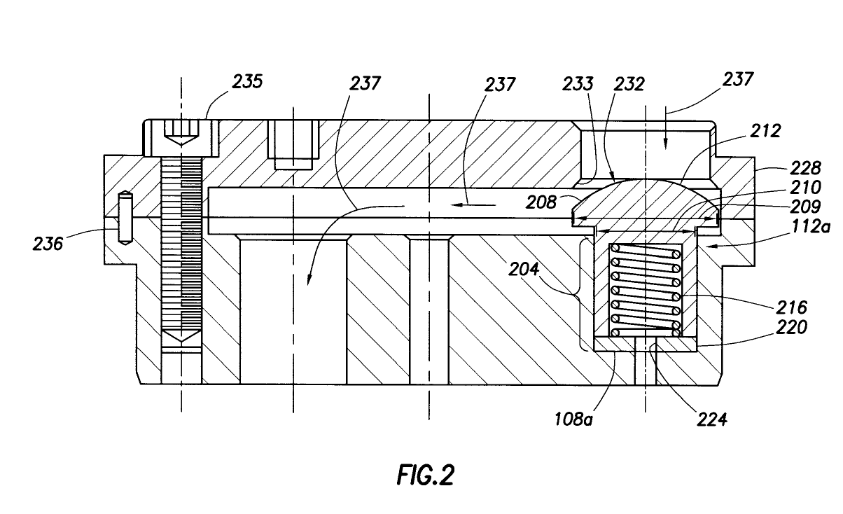

A plurality of miniature poppets 112 (shown as 112a-i in FIG. 1) with a maximum outer diameter of one inch and preferably 0.9 inches or smaller are disposed in the plurality of counter bores 108a-i. Each of the plurality of poppets 112 seats in a respective one of the plurality of counter bores 108 provided in the cage 104. In the embodiment of FIG. 2, the poppet valve assembly 102 includes nine poppets 112a-i that are arranged in the cage 104 around two diameters 116 and 120. A first smaller diameter 116 has three poppets 112a-c that are substantially equally spaced around the smaller diameter 116, and a second larger diameter 120 has six poppets 112d-i that are substantially equally spaced around the larger diameter 120. In other embodiments, the poppet valve assembly 102 may include a plurality of poppets 112 positioned according to any conventional arrangement. In any event, it is desirable that by utilizing unconventionally small diameter poppets, a greater surface area of cage 104 can be covered by poppets 112, thereby permitting the same volume of gas to pass therethrough, but in a more controllable manner.

The poppet 112 is fabricated from a high performance engineering thermoplastic. However, in other embodiments, the poppet valve assembly 102 may be fabricated from other materials, including without limitation, hardened steel, other metals or metal alloys.

Referring now to FIG. 2, a partial cross-sectional view of a portion of the poppet valve assembly 102 that includes a poppet 112 is shown. The plurality of poppets in assembly 102 are substantially similar to one another. Of course, those skilled in the art will appreciate that in other embodiments, the poppets 112 may vary as described with respect to embodiments of the present disclosure. In any event, poppet 112 includes a stem 204 and a head 208, and is substantially mushroom-shaped, because the head 208 is larger than the stem 204.

In one embodiment, the head 208 has a maximum diameter 209 that is approximately 0.71 inches, and the stem 204 has a maximum diameter 210 that is approximately 0.446 inches. In another embodiment, the maximum diameter 209 of the head 208 may be less than approximately 0.75 inches, and the maximum diameter 210 of the stem 204 may be less than approximately 0.446 inches. In yet another embodiment, the maximum diameter 209 of the head 208 may be less than approximately 1 inch. The head 208 includes a sealing surface 212 that has a diameter that is larger than the maximum diameter 210 of the stem 204.

The stem 204 of poppet 112 is disposed in a counter bore 108. Preferably, the stem 204 is hollow, and is adapted to house or guide a spring 216. The spring 216 is disposed in the stem 204 so as to seat in the counter bore 108. A lift spacer 220, having an aperture 224 therethrough, is positioned at the bottom of counter bore 108. The spring 216 is disposed to urge the poppet 112 toward a seat plate 228 overlying the cage 104, and thereby place the poppet 112 in a closed position. Like poppet 112, lift spacer 220 may be fabricated from a high performance engineering thermoplastic. However, in other embodiments, lift spacer 220 may be fabricated from other materials, including without limitation, hardened steel, other metals or metal alloys.

The seat plate 228 includes a plurality of through bores 232, each axially aligned with a counter bore 108. The through bore 232 is sized to have a smaller diameter than the maximum diameter 209 of the head 208. An edge 233 of the through bore 232 that interfaces with the sealing surface 212 is disposed to form a seat for receipt of head 208, preferably forming a metal to metal seal between the seat plate 228 and the head 208. In one preferred embodiment, edge 233 has a 45 degree chamfer to enhance sealing between the head 208 and the seat plate 228. However, in other embodiments, other shaped edges may be used to create a seal or seat. For example, the angle of edge 233 may be selected to correspond with the angle or shape of the sealing surface 212 that interfaces with the seat plate 228.

Each through bore 232 represents an independent, separately controllable orifice through which fluid may flow. By decreasing the size of the orifices, but increasing their number in poppet valve assembly 102, more precise control of fluid flow, namely gas flow into a high speed compressor, can be achieved.

Preferably, the seat plate 228 is a replaceable seat plate, and includes a hardened steel plate that covers the poppet valve assembly 102. In other embodiments, the seat plate 228 may include a plate that is manufactured using other materials. Most desirably, seat plate 228 is replaceable in the event of debris damage or excessive wear thereto. Conventional poppet valves do not include replaceable seat plates, and therefore the entire valve seat-body of such conventional poppet valve assemblies must be replaced. Thus, in this regard, seat plate 228 is readily detachable from cage 104. Although any conventional fastener may be utilized, in the embodiment of FIG. 2, seat plate 228 is attached to cage 104 with threaded fasteners 235.

The poppet valve assembly 102 may also includes an alignment pin 236 that is positioned between the seat plate 228 and the cage 104. The alignment pin 236 facilitates proper alignment of components of the poppet valve assembly 102 during manufacture and removal and replacement of seat plate 228. Again, because conventional assemblies were not replaceable, such alignment pins 236 were not necessary.

The cage 104 and the seat plate 228, when joined together, form a flow channel 237 that extends from the through bore 232 through the poppet valve assembly 102. The cage 104 and lift spacer 220 provide a versatile poppet valve assembly 102 that enables multiple flow area configurations, simplified assembly and manufacturing, and enhanced flow characteristics.

The flow area of the poppet valve assembly 102, and specifically, the flow through each through bore 232, can be readily adjusted by adjusting the lift spacer 220 underlying the poppet 112. The amount of axial movement of the poppet 112 is controlled by the lift spacer 220, which in turn controls the amount of fluid flow through the poppet valve assembly 102. The through bore 232, and subsequently the open cross-sectional area between the through bore 232 and head 208, is generally controlled by the lift spacer 220 and the sizing of the poppet itself, as well as the reduced opening in the seating surface.

As specified above, the poppets 112 are smaller than conventional poppets. For example, a conventional poppet may have a head 208 that has a diameter that ranges from approximately 1 inch to approximately 1 and ⅛ inches. In contrast, the head 208 of each of the poppets 112 has a maximum diameter 209 that is preferably approximately 0.71 inches, although this dimension may range in one preferred embodiment from approximately 0.5 inches to 0.9 inches. In another preferred embodiment, valve 102 includes at least 6 poppets 112, while in another preferred embodiment, valve 102 includes at least 9 poppets 112. Of course, the number of poppets 112 depends in part on the size of cage 104. However, it has been found that approximately 50% to 100% more surface area of cage 104 can be covered with poppet heads 208 as compared to the prior art, thereby enhancing the fluid control through assembly 102.

The poppet valve assembly 102 enables more precise control of fluid flow as compared to conventional poppet valve assemblies by allowing the use of smaller valves with smaller cross-sectional fluid flow openings. Because of the relatively small size of the poppets 112 of the present disclosure as compared to conventional poppets, a larger number of poppets 112 of the present disclosure may be disposed in the same dimensional envelope. As a result, fluid flow may be more precisely controlled.

In high-speed compressor applications, precise control of fluid flow is important. The poppet valve assembly 102 may be used in high-speed compressor applications. In an embodiment, the high-speed compressor application may require operation at a speed that is between approximately 600 rpm and approximately 1500 rpm. In contrast, conventional compressors, using conventional poppet valve assemblies, are limited to operating at a much slower relative speed. For example, a conventional compressor using conventional poppet assemblies might be limited to operating at a speed that is between approximately 200 rpm and approximately 600 rpm.

Furthermore, because the poppets 112 include heads 208 that have a diameter that is larger than the diameter of the respective through bores 232 the sealing surface 212 and flow window of the poppets 112 extend beyond the maximum diameter 210 of the stem 204. One benefit of the foregoing is that it allows for use of a larger through bore 232 while maintaining a relatively small guiding body. While the same size and shape heads 208 for the plurality of poppets 112 is shown in FIG. 1, in other embodiments, the size and/or shape of the heads 208 may be varied in a poppet valve assembly 112 to achieve the desired flow characteristics for the particular compressor with which it is used.

In conventional poppet valve assemblies, conventional lift spacers are used as cushions or buffers and are not designed to control movement of the poppets. In contrast, the lift spacer 220 is designed to control movement of the poppets 112. The lift spacer 220 under the poppet 112 can be customized to vary the clearance between the sealing surface 112 and the through bore 232, and thus precisely control fluid flow. In other embodiments, the thickness of the lift spacers 220 and the dimensions of the head 208 may be varied depending on the desired fluid flow characteristics across the plurality of poppets 112 for a particular high speed compressor application.

With respect to the poppet valve assembly 102 specifically shown in FIGS. 1 and 2, the lift spacer 220 that is disposed under the poppet 112a has substantially the same dimensions as the lift spacers that are disposed under the poppets 112b-i. However, in another embodiment, each of the lift spacers that are disposed under the poppets 112a-i has dimensions that are varied depending on the desired fluid flow characteristics across the poppets 112a-i. For example, the lift spacer 220 that is disposed under the poppet 112a may be a different height as compared to a second lift spacer that is disposed under one of the poppets 112b-i.

During operation of the poppet valve assembly 102 in a high-speed compressor, the tight fit of the components of the poppet valve assembly 102, as compared to conventional poppet valve assemblies, may cause one or more poppets to become “air locked.” However, the aperture 224 that is disposed in the lift spacer 220 enables back-venting of fluid, thereby preventing the plurality of poppets 112 from becoming “air-locked.”

Another advantage of embodiments of the present disclosure is that a standard poppet 112a-i may be utilized for all counter bores 108a-i, while allowing the flow area through each through bore 232 to be individually adjusted by varying the thickness of the lift spacer 220.

While the system of the invention is best described in the context of a high speed compressor application, those skilled in the art will understand that the invention may also be utilized in other applications where precise control of fluid flow is required.

Although only a few exemplary embodiments of this invention have been described in detail above, those skilled in the art will readily appreciate that many modifications are possible in the exemplary embodiments without materially departing from the novel teachings and advantages of this disclosure.

What is claimed is:

1. A poppet valve assembly, comprising:
a cage, said cage including a plurality of counter bores disposed therein;
a plurality of poppets, each poppet including a stem and a head, wherein the head has a maximum diameter that is less than approximately one inch, and wherein the stem is disposed in a corresponding one of the said plurality of counter bores;
a seat plate overlying said cage, said seat plate including a plurality of through bores axially aligned with the plurality of counter bores of the cage, wherein each of the plurality of through bores is sized to have a smaller diameter than the maximum diameter of the head; and
a lift spacer disposed in a plurality of counter bores.

2. The poppet valve assembly of claim 1, wherein the stem of a poppet is at least partially hollow, and further comprising a spring disposed in the partially hollow stem of each of a plurality of poppets so as to seat in the corresponding one of the plurality of counter bores.

3. The poppet valve assembly of claim 1, wherein said lift spacer includes an aperture therethrough.

4. The poppet valve assembly of claim 1, wherein the maximum diameter of the head is no greater than approximately 0.75 inches.

5. The poppet valve assembly of claim 1, wherein the seat plate is removably coupled to the cage.

6. The poppet valve assembly of claim 1, wherein an edge of each of the plurality of through bores that interfaces with the head is chamfered.

7. The poppet valve assembly of claim 6, wherein a first lift spacer disposed in a first of said plurality of counter bores has different dimensions than a second lift spacer disposed under a second of said plurality of counter bores.

8. The poppet valve assembly of claim 1, wherein a combined surface area of the plurality of poppets is at least approximately 50% of a surface area of the cage.

9. An apparatus, the apparatus comprising:
a poppet valve assembly, wherein the poppet valve assembly comprises:
a cage, said cage including a plurality of counter bores disposed therein;
a plurality of poppets, each poppet including a stem and a head, wherein the head has a maximum diameter that is less than approximately 0.75, and wherein the stem is disposed in a corresponding one of the said plurality of counter bores; and
a seat plate overlying said cage, said seat plate including a plurality of through bores axially aligned with the plurality of counter bores of the cage, wherein each of the plurality of through bores is sized to have a smaller diameter than the maximum diameter of the head.

10. The apparatus of claim 9, the poppet valve assembly further comprising a spring disposed in the stem of each of the plurality of poppets so as to seat in the corresponding one of the plurality of counter bores.

11. The apparatus of claim 9, further comprising a lift spacer disposed in a plurality of counter bores, wherein each lift spacer includes an aperture therethrough.

12. The apparatus of claim 9 wherein the maximum diameter of the head is in the range of approximately 0.50-0.75 inches.

13. The apparatus of claim 9, wherein the seat plate is removably coupled to the cage.

14. The apparatus of claim 9, comprising at least 9 through bores and at least 9 corresponding poppets.

15. The apparatus of claim 9, wherein the cage is circular in shape and a first set of poppets is arranged about a first circumference defined on said cage and a second set of poppets is arranged about a second circumference defined on said cage.

16. The apparatus of claim 9, wherein a combined surface area of the plurality of poppets is at least approximately 50% of a surface area of the cage.

17. A compressor system, the compressor system comprising:
a compressor operable at speeds of at least 600 rpm, said compressor further comprising a poppet valve assembly, wherein the poppet valve assembly comprises:
a cage, said cage including a plurality of counter bores disposed therein;
a plurality of poppets, each poppet including a stem and a head, wherein the head has a maximum diameter that is less than approximately 0.9 inches, and wherein the stem is disposed in a corresponding one of the said plurality of counter bores;
a seat plate overlying said cage, said seat plate including a plurality of through bores axially aligned with the plurality of counter bores of the cage, wherein each of the plurality of through bores is sized to have a smaller diameter than the maximum diameter of the head; and
a lift spacer disposed in a plurality of counter bores.

18. The system of claim 17, wherein the stem of a poppet is at least partially hollow, and wherein the poppet valve assembly further comprises a spring disposed in the stem of each of the plurality of poppets so as to seat in the corresponding one of the plurality of counter bores.

19. The system of claim 17, wherein said lift spacer includes an aperture therethrough.

20. The system of claim 17, wherein the maximum diameter of the head is greater than approximately 0.75 inches.

21. The system of claim 17, wherein the seat plate is removably coupled to the cage.

22. The system of claim 17, wherein a first lift spacer disposed in a first of said plurality of counter bores has different dimensions than a second lift spacer disposed under a second of said plurality of counter bores.

23. The system of claim 17, wherein said compressor is operable at speeds of at least 1000 rpms.

24. The system of claim 17, wherein a combined surface area of the plurality of poppets is at least approximately 50% of a surface area of the cage.
